(19) United States
(12) Patent Application Publication
(10) Pub. No.: US 2025/0228728 A1
(43) Pub. Date: Jul. 17, 2025

(54) FLEXIBLE REHABILITATION GLOVE BASED ON HYBRID ACTUATORS

(71) Applicant: SOUTHEAST UNIVERSITY, Nanjing City, Jiangsu (CN)

(72) Inventors: Aiguo SONG, Nanjing City, Jiangsu (CN); Jianwei LAI, Nanjing City, Jiangsu (CN); Wei GE, Nanjing City, Jiangsu (CN); Huijun LI, Nanjing City, Jiangsu (CN); Ting WU, Nanjing City, Jiangsu (CN); Ye LI, Nanjing City, Jiangsu (CN)

(21) Appl. No.: 18/025,991

(22) PCT Filed: Oct. 13, 2022
(86) PCT No.: PCT/CN2022/125131

§ 371 Date: Mar. 27, 2025

(30) Foreign Application Priority Data
Oct. 8, 2022 (CN) 202211220003.7

(51) Int. Cl. A61H 1/02

(52) U.S. Cl. CPC A61H 1/0288; A61H 2201/1635; A61H 2205/067

(57) ABSTRACT

The present disclosure discloses a flexible rehabilitation glove based on hybrid actuators. The flexible rehabilitation glove includes five hybrid actuators and an actuator control box, each hybrid actuator includes an actuator end mounting seat, a flexible actuator, a TPFE water pipe, a flexible actuator front section mounting seat, a flexible actuator air pipe, an air pipe connecting seat II, an SMA spring actuator, an air pipe connecting seat I and a cooling water pipe, the control box includes an air pump, a filter, a water pump and a water tank, a proportional valve and a control circuit board inside, and includes an actuator control box body, a control box cover, a main switch, a button and a voltage display outside, and the filter is connected to the air pump and the electrical proportional valve respectively. The flexible rehabilitation glove has the characteristics of large output torque and high force-mass ratio of SMA of the flexible actuator, the problem of only one-way movement of a traditional flexible actuator is solved, the fingers of the patient are driven to move in two directions, and sufficient working torque and working space in the two directions are provided for the patient.

### TECHNICAL FIELD

The present disclosure belongs to the field of upper limb exoskeleton rehabilitation robots, and particularly relates to a flexible exoskeleton glove system for hand rehabilitation training.

### BACKGROUND

Stroke is a common disease caused by cerebrovascular diseases, and the number of patients with hand dysfunction caused by stroke increases gradually. The hand function is an important factor that dominates patients' life quality, and the complete hand function can help patients to meet various complex life needs and complete daily work, and can also be used as a tool to express emotions.

A traditional rehabilitation robot uses a rigid connecting rod structure to help patients to extend and bend, and the rigid connecting rod structure is used for driving fingers of the patients to move on a preset track. The rigid structure has the problems of difficulty in wearing, alignment of rotation centers and the like.

The flexible rehabilitation robot can solve the problems. Due to the flexibility of flexible materials, the robot based on a flexible actuator has been extensively studied:
the patent CN 107242958 B provides an exoskeleton glove rehabilitation training system based on a flexible actuator, and the patent can help patients to perform bending rehabilitation training; and
the patent CN 111685964 A provides a hand rehabilitation apparatus based on shape memory alloy, and the apparatus uses ropes and the shape memory alloy to drive patients to contract and extend hands for performing rehabilitation training on fingers of the patients.

However, the above patents also have some problems:
1. absence of the rehabilitation apparatus in extension and bending directions; and
2. insufficient output force and working space of the rehabilitation apparatus.

Therefore, further improvement is needed.

### SUMMARY

In order to solve the above problems, the present disclosure discloses a flexible rehabilitation glove based on hybrid actuators, which can provide output force and working space in bending and extension directions for fingers of a patient and overcome the defect of only one-way movement of a traditional flexible actuator.

In order to achieve the above objective, the present disclosure has the following technical solutions:
a flexible rehabilitation glove based on hybrid actuators, including five hybrid actuators and an actuator control box; and
each hybrid actuator includes an actuator end mounting seat, a flexible actuator, a TPFE water pipe, a flexible actuator front section mounting seat, a flexible actuator air pipe, an air pipe connecting seat II, an SMA spring actuator, an air pipe connecting seat I and a cooling water pipe, and
the hybrid actuators are connected to the glove by using elastic bands, and the hybrid actuators are extended and bent to drive the fingers of the patient to move.

The flexible actuator is made of silica gel, is of a multi-cavity structure and is composed of upper and lower parts, as shown in FIG. 7, an upper layer is wavy, a hollow cavity is formed between every two wave crests, a lower layer is a rectangle, and a groove for conducting air is formed in the middle. The flexible actuator is configured to that wavy cavities are thin in a contact surface and thick in a non-contact surface, in the process of inflating the flexible actuator, the deformation of the contact surface is large, and the cavities extrude to each other, which results in the bending of the actuator.

Two ends of the flexible actuator are respectively connected to the flexible actuator front section mounting seat and a flexible actuator end mounting seat, the interior of the actuator is hollow, the bending and extension of the flexible actuator are achieved by inflation and deflation, the flexible actuator is connected to an air pump through the flexible actuator air pipe, and internal air pressure is controlled by an electrical proportional valve through a control program in a control circuit board.

The SMA spring actuator is sleeved on the cooling water pipe, and the water pipe is used as a guide rail for rope movement and has the effect of cooling the spring actuator by lowering the temperature of the water pipe by means of internal water flow and enabling the water pipe to make full contact with the SMA spring actuator. The SMA spring actuator passes through two holes in the flexible actuator front section mounting seat and two holes in the flexible actuator by a rope and is connected to the actuator end mounting seat, and the flexible actuator can be assisted to provide a reverse extension force by tension of a spring.

The TPFE water pipe is placed between the two holes in the flexible actuator, and the water pipe can reduce the force of friction caused by mutual movement of the rope and the flexible actuator, so that the efficiency of the system is improved.

The air pipe connecting seat I and the air pipe connecting seat II are respectively installed on two ends of each of the cooling water pipe and the flexible actuator, and the position of the water pipe is fixed by using the two connecting seats. The air pipe connecting seat I fixes the end position of the SMA spring actuator, and the air pipe connecting seat II limits the range of movement of the other end of the SMA spring actuator.

The control box includes an air pump, a filter, a water pump and a water tank, a proportional valve and a control circuit board inside, and includes an actuator control box body, a control box cover, a main switch, a button and a voltage display outside.

The air pump can provide 250 KPa of air pressure for the system, and the flexible actuator can achieve the freedom of bending by increasing the internal air pressure of the flexible actuator.

The filter is connected to the air pump and the electrical proportional valve respectively, and impurities and water vapor in air can be filtered out by using the filter, so that the damage of impurities to the proportional valve is reduced.

The water pump and water tank are mainly used for providing low-temperature water flow for the cooling water pipe so as to cool the SMA spring actuator.

The actuator control box and the control box cover are connected by the attractive force of magnets at four corners so as to be conveniently opened and closed.

The button can be programmed to set several special gestures. The glove can be controlled by the button to drive the fingers of the patient to carry out special gestures so as to help the patient to achieve the functions in daily life.

### Driving Principle:

Each hybrid actuator is composed of a bending actuator and an extension actuator, where the bending actuator is a flexible actuator, and the extension actuator is an SMA spring actuator.

The flexible actuator has an initial state and a pressurizing state, and the flexible actuator is in a rectangular shape in the initial state and in an arc shape in the pressurizing state. By controlling the internal pressure of the flexible actuator, the bending angle of the flexible actuator can be changed so as to achieve the objective of controlling the bending and extension of the flexible actuator. The flexible actuator is in the rectangular shape in the initial state, however, the internal stress of the flexible actuator is low, the finger resistance cannot be overcome to return to the extension state, and therefore, the extension actuator, i.e., the SMA spring actuator, is additionally arranged.

The SMA spring actuator is a spring made of memory alloy, the memory alloy has two states of martensite and austenite, and the states are converted by controlling the temperature of SMA. When the temperature of the memory alloy is relatively low, the SMA spring is in the state of martensite, at the moment, an elastic coefficient of the SMA spring is relatively low, and an elastic force of the SMA spring is relatively low; and when the temperature of the memory alloy is relatively high, the SMA spring is in the state of austenite, at the moment, the elastic coefficient of the SMA spring is relatively high, and the elastic force of the spring is relatively high.

The control block diagram of the specific driving principle is shown in FIG. 6:

During movement in the bending direction, the internal pressure of the flexible actuator increases to drive the rope, the rope moves to pull the SMA spring actuator, and in the condition of no heating, the SMA spring actuator is cooled by the cooling water pipe, so that during extension, the SMA spring is in the state of martensite, and the SMA material of martensite has low rigidity and thus has low damping on the movement of the flexible actuator.

In addition, during movement in the extension direction, the rigidity of the SMA spring is increased by electrifying and heating the SMA spring, the SMA spring pulls the rope to drive the flexible actuator end mounting seat to reversely move, and meanwhile, the internal pressure of the flexible actuator decreases, so that the flexible actuator is in the initial state and thus has low damping on the movement of the SMA spring.

In order to preferably assist patients in daily life activities, modeling analysis is performed on the hybrid actuators.

The modeling of the hybrid actuators mainly includes the modeling of the flexible actuator and the SMA spring actuator.

### 1. Modeling of Memory Alloy Spring Actuator

Hooke's Law of Elasticity states:

$${F}_{SMA} = kX$$

where k is the elastic coefficient of the spring, and x is the deformation quantity of the spring.

In the condition of guaranteeing the accuracy of the actuator, the SMA memory alloy spring is simplified to obtain the elastic coefficient of SMA memory alloy:

$$k = \{ \begin{matrix}{k}_{A} ( {A}_{f} \leq T ) \\ {k}_{M} ( T \leq {A}_{s} )\end{matrix}$$

where k_{A} is the elastic coefficient of the memory alloy spring in the state of austenite, and an expression is

$${k}_{A} = \frac{{C}_{2} {G}_{A}}{{C}_{1}} ;$$

and k_{M} is the elastic coefficient of the memory alloy spring in the state of martensite, and an expression is

$${k}_{M} = \frac{{C}_{2} {G}_{M}}{{C}_{1}} .$$

T is the temperature of the SMA spring, the temperature at which the austenite phase transformation begins is Aₛ, and the temperature at which the austenite phase transformation ends is A_{f}, where C₁ and C₂ are constants, and expressions are

$${C}_{1} = \frac{8 {k}_{s} D}{π {d}^{3}} and {C}_{2} = \frac{d}{π {D}^{2} N} .$$

In the expressions, kₛ is the stress-corrected elastic coefficient, and the expression is

$${k}_{s} = \frac{4 C - 1}{4 C - 4} + \frac{0.165}{C}$$

In the expression, C is the spring index,

$$C = \frac{D}{d} ,$$

D is the diameter of the spring, d is the wire diameter of the spring, and N is the number of coils.

### 2. Modeling of Flexible Actuator

During inflation, the pressure of each cavity of the actuator is the same. The internal pressure of an air bag is set to P, force analysis is performed on the single surface of the actuator, the internal stress of the section of a base is expressed as σ, and it can be seen from a force balance equation:

$$σ {t}^{2} = {P ( h + t )}^{2}$$

In the expression, h is the internal height of the cavity, and t is the thickness of the cavity base.

On the basis of a Yeoh model, an energy equation using a typical two-parameter form is

$$U = {C}_{3} ( I - 3 ) + {{C}_{4} ( I - 3 )}^{2} = {{C}_{3} ( λ - \frac{1}{λ} )}^{2} + {{C}_{4} ( λ - \frac{1}{λ} )}^{4}$$

In the expression, C₃ and C₄ are coefficients, C₃=0.11 and C₄=0.02, I is the deformation tensor invariant, and λ is the principal elongation ratio.

The internal stress is expressed as

$$σ = \frac{\partial U}{\partial λ} ,$$

and the relationship between the internal stress σ and the principal elongation ratio λ can be expressed as

$$σ = \frac{{λ}^{4} - 1}{{λ}^{3}} ( 2 {C}_{3} + 4 {{C}_{4} ( λ - \frac{1}{λ} )}^{2} )$$

The above expression is expanded, and two or more-order small quantities are ignored to obtain.

$$σ = 8 {C}_{3} ( {λ}_{3} - 1 )$$

The principal elongation ratio of the single air bag of the flexible actuator is

$${λ}_{1} = \frac{θ}{sin θ} ,$$

θ represents the bending angle of the single air bag under certain internal air pressure, i.e.,

$$θ = \frac{ϕ}{N} ,$$

ϕ is the bending angle of the flexible actuator, and N is the number of air bags.

### 3. Modeling of Hybrid Actuators

An output force model of the hybrid actuators is obtained according to the force balance relation:

$$σ - {F}_{SMA} - {F}_{0} - {F}_{Muscle} = 0$$

In the expression: F_{SMA} is the output force of shape memory alloy, F₀ is the initial force of the hybrid actuators, and F_{Muscle} is the auxiliary force of the hybrid actuators and human fingers.

Models of the SMA spring actuator and the flexible actuator are substituted into the above expression to obtain the auxiliary force of the hybrid actuators to the fingers of a patient:

$${F}_{Muscle} = \frac{{{P}_{i} ( h + t )}^{2}}{{t}^{2}} - k X - {F}_{0}$$

In the expression, x is the elongation of the spring, an expression is X=L*(λ−1)*2 Pᵢ is the internal pressure of the flexible actuator at the moment i, and L is the length of the actuator.

The present disclosure has the beneficial effects that:
1. The hybrid actuators have the characteristics of large output torque and high force-mass ratio of SMA of the flexible actuator, the problem of only one-way movement of a traditional flexible actuator is solved, the fingers of the patient are driven to move in two directions, and sufficient working torque and working space in the two directions are provided for the patient.
2. According to the hybrid actuators, the SMA spring actuator is cooled by water, so that the cooling speed of the actuator can be increased, and the response speed of the actuator is increased.
3. Models of the hybrid actuators are established, and the bending angle and the auxiliary force of the actuators are calculated according to the models by using the stability of the memory alloy spring actuator and the internal pressure of the flexible actuator of the hybrid actuators.

### BRIEF DESCRIPTION OF THE DRAWINGS

FIG. 1 is a wearing diagram of the hybrid actuators of the present disclosure during extension.

FIG. 2 is a wearing diagram of the hybrid actuators of the present disclosure during bending.

FIG. 3 is a structure diagram of the control box of the present disclosure.

FIG. 4 is a structure diagram of the interior of the control box in FIG. 3.

FIG. 5 is a wearing diagram of the flexible actuator of the present disclosure.

FIG. 6 is a control block diagram of the flexible actuator of the present disclosure.

FIG. 7 is a section diagram of the flexible actuator of the present disclosure.

FIG. 8 is a bending diagram of the flexible actuator of the present disclosure.

FIG. 9 is an extension diagram of the flexible actuator of the present disclosure.

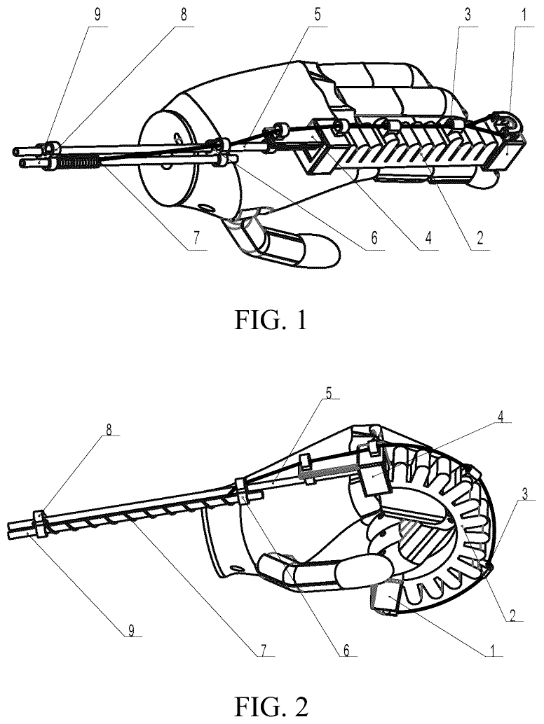

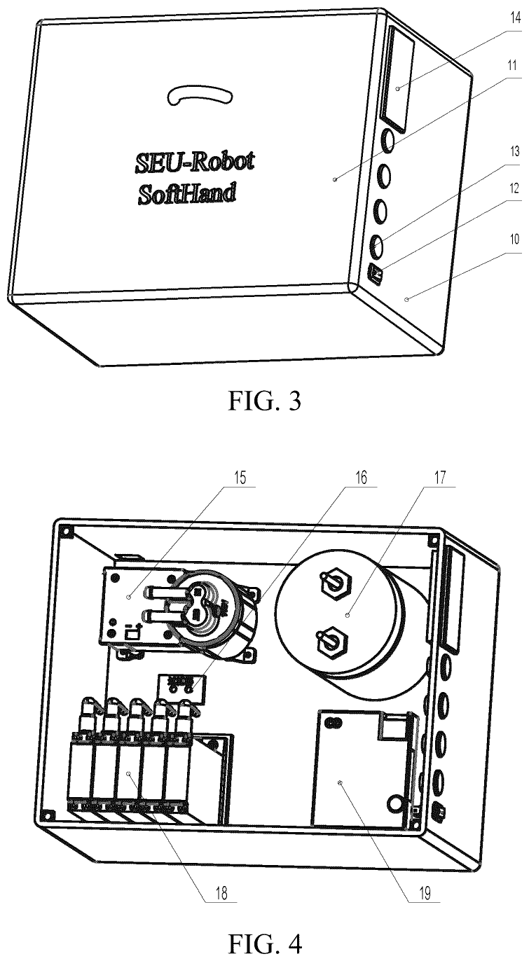

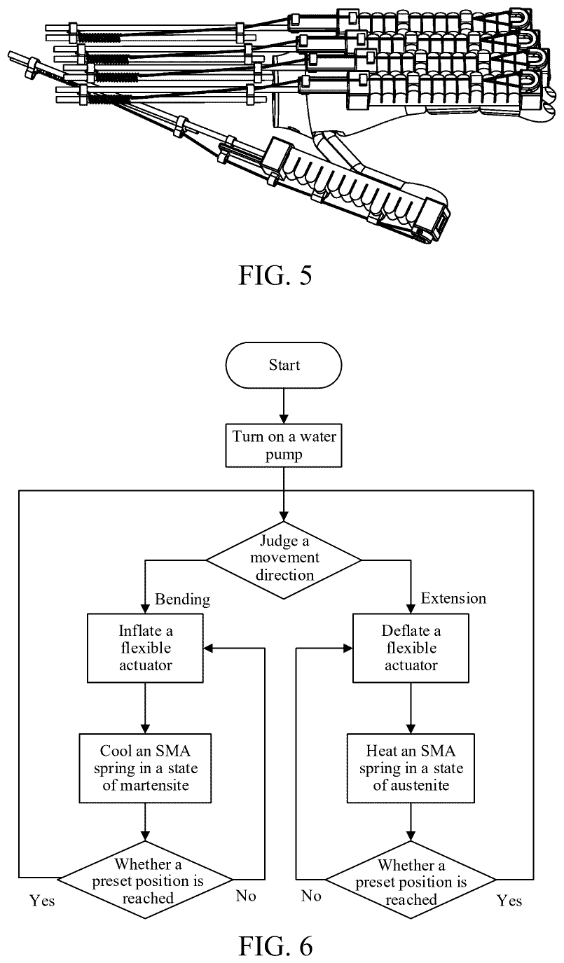

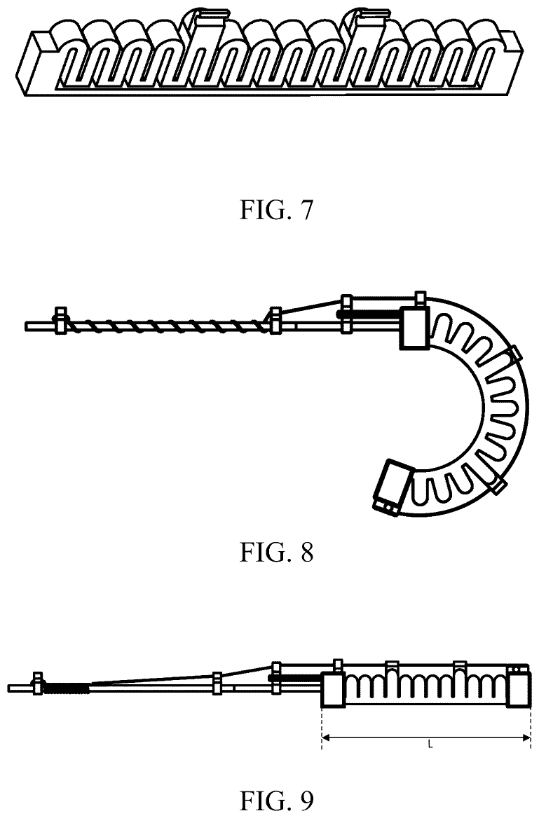

In the figures, 1 represents the actuator end mounting seat, 2 represents the flexible actuator, 3 represents the TPFE water pipe, 4 represents the flexible actuator front section mounting seat, 5 represents the flexible actuator air pipe, 6 represents the air pipe connecting seat II, 7 represents the SMA spring actuator, 8 represents the air pipe connecting seat I, 9 represents the cooling water pipe, 10 represents the actuator control box, 11 represents the control box cover, 12 represents the main switch, 13 represents the button, 14 represents the voltage display, 15 represents the air pump, 16 represents the filter, 17 represents the water pump and water tank, 18 represents the proportional valve, and 19 represents the control circuit board.

### DETAILED DESCRIPTION

The present disclosure is further described with reference to the drawings and specific implementations below. It should be understood that the following specific implementations are only used for describing the present disclosure but are not used for limiting the scope of the present disclosure.

As shown in the figure, the flexible rehabilitation glove based on hybrid actuators provided by the present disclosure includes five hybrid actuators and an actuator control box; and
each hybrid actuator includes an actuator end mounting seat 1, a flexible actuator 2, a TPFE water pipe 3, a flexible actuator front section mounting seat 4, a flexible actuator air pipe 5, an air pipe connecting seat II 6, an SMA (memory alloy) spring actuator 7, an air pipe connecting seat I 8 and a cooling water pipe 9.

The hybrid actuators are connected to the glove by using elastic bands, and the hybrid actuators are extended and bent to drive the fingers of the patient to move.

The flexible actuator 2 is made of silica gel, and the size of the flexible actuator is increased by increasing the internal pressure of the flexible actuator. Meanwhile, the size of the flexible actuator is designed as follows: an axial inner wall of an air cavity of the actuator is thin, a radial inner wall of the air cavity of the flexible actuator is thick, thus, air pressure is increased, so that the axial deformation of the flexible actuator is large, and the radial deformation is almost zero.

Two ends of the flexible actuator 2 are respectively connected to the flexible actuator front section mounting seat 4 and a flexible actuator end mounting seat 1, the interior of the actuator is hollow, the bending and extension of the flexible actuator are achieved by inflation and deflation, the flexible actuator 2 is connected to an air pump 15 through the flexible actuator air pipe 5, and internal air pressure is controlled by an electrical proportional valve 18 through a control program in a control circuit board 19.

The SMA spring actuator is sleeved on the cooling water pipe, and the water pipe is used as a guide rail for rope movement and has the effect of cooling the spring actuator by lowering the temperature of the water pipe by means of internal water flow and enabling the water pipe to make full contact with the SMA spring actuator 7. The SMA spring actuator 7 passes through two holes in the flexible actuator front section mounting seat 4 and two holes in the flexible actuator 2 by a rope and is connected to the actuator end mounting seat 1, and the flexible actuator 2 can be assisted to provide a reverse extension force by tension of a spring.

The TPFE water pipe is placed between the two holes in the flexible actuator 2, and the water pipe can reduce the force of friction caused by mutual movement of the rope and the flexible actuator, so that the efficiency of the system is improved.

The air pipe connecting seat I 8 and the air pipe connecting seat II 6 are respectively installed on two ends of each of the cooling water pipe 9 and the flexible actuator 2, and the position of the water pipe is fixed by using the two connecting seats. The air pipe connecting seat I 8 fixes the end position of the SMA spring actuator 7, and the air pipe connecting seat II 6 limits the range of movement of the other end of the SMA spring actuator 7.

The control box 10 includes an air pump 15, a filter 16, a water pump and a water tank 17, a proportional valve 18 and a control circuit board 19 inside, and includes an actuator control box body, a control box cover 11, a main switch 12, a button 13 and a voltage display 14 outside.

The air pump 15 can provide 250 KPa of air pressure for the system, and the flexible actuator can achieve the freedom of bending by increasing the internal air pressure of the flexible actuator.

The filter 16 is connected to the air pump 15 and the electrical proportional valve 18 respectively, and impurities and water vapor in air can be filtered out by using the filter, so that the damage of impurities to the proportional valve is reduced.

The water pump and water tank 17 are mainly used for providing low-temperature water flow for the cooling water pipe so as to cool the SMA spring actuator.

The actuator control box 10 and the control box cover 11 are connected by the attractive force of magnets at four corners so as to be conveniently opened and closed.

The button 13 can be programmed to set several special gestures. The glove can be controlled by the button to drive the fingers of the patient to carry out special gestures so as to help the patient to achieve the functions in daily life.

During movement in the bending direction, the internal pressure of the flexible actuator increases to drive the rope, the rope moves to pull the SMA spring actuator, and in the condition of no heating, the SMA spring actuator is cooled by the cooling water pipe, so that during extension, the SMA spring is in the state of martensite, and the SMA material of martensite has low rigidity and thus has low damping on the movement of the flexible actuator.

In addition, during movement in the extension direction, the rigidity of the SMA spring is increased by electrifying and heating the SMA spring, the SMA spring pulls the rope to drive the flexible actuator end mounting seat to reversely move, and meanwhile, the internal pressure of the flexible actuator decreases, so that the flexible actuator is in the initial state and thus has low damping on the movement of the SMA spring.

In order to preferably assist patients in daily life activities, modeling analysis is performed on the hybrid actuators.

The modeling of the hybrid actuators mainly includes the modeling of the flexible actuator and the SMA spring actuator.

### 1. Modeling of Memory Alloy Spring Actuator

Hooke's Law of Elasticity states:

$${F}_{SMA} = k X$$

where k is the elastic coefficient of the spring, and x is the deformation quantity of the spring.

In the condition of guaranteeing the accuracy of the actuator, the SMA memory alloy spring is simplified to obtain the elastic coefficient of SMA memory alloy:

$$k = \{ \begin{matrix}{k}_{A} ( {A}_{f} \leq T ) \\ {k}_{M} ( T \leq {A}_{s} )\end{matrix}$$

where k_{A} is the elastic coefficient of the memory alloy spring in the state of austenite, and an expression is

$${k}_{A} = \frac{{C}_{2} {G}_{A}}{{C}_{1}} ;$$

and k_{M} is the elastic coefficient of the memory alloy spring in the state of martensite, and an expression is

$${k}_{M} = \frac{{C}_{2} {G}_{M}}{{C}_{1}} .$$

T is the temperature of the SMA spring, the temperature at which the austenite phase transformation begins is Aₛ, and the temperature at which the austenite phase transformation ends is A_{f}, where C₁ and C₂ are constants, and expressions are

$${C}_{1} = \frac{8 {k}_{s} D}{π {d}^{3}} and {C}_{2} = \frac{d}{π {D}^{2} N} .$$

In the expressions, kₛ is the stress-corrected elastic coefficient, and the expression is

$${k}_{s} = \frac{4 C - 1}{4 C - 4} + \frac{0.165}{C}$$

In the expression, C is the spring index,

$$C = \frac{D}{d} ,$$

D is the diameter of the spring, d is the wire diameter of the spring, and N is the number of coils.

### 2. Modeling of Flexible Actuator

During inflation, the pressure of each cavity of the actuator is the same. The internal pressure of an air bag is set to P, force analysis is performed on the single surface of the actuator, the internal stress of the section of a base is expressed as σ, and it can be seen from a force balance equation:

$$σ {t}^{2} = {P ( h + t )}^{2}$$

In the expression, h is the internal height of the cavity, and t is the thickness of the cavity base.

On the basis of a Yeoh model, an energy equation using a typical two-parameter form is

$$U = {C}_{3} ( I - 3 ) + {{C}_{4} ( I - 3 )}^{2} = {{C}_{3} ( λ - \frac{1}{λ} )}^{2} + {{C}_{4} ( λ - \frac{1}{λ} )}^{4}$$

In the expression, C₃ and C₄ are coefficients, C₃=0.11 and C₄=0.02, I is the deformation tensor invariant, and λ is the principal elongation ratio.

$$σ = \frac{\partial U}{\partial λ} ,$$

The internal stress is expressed as and the relationship between the internal stress σ and the principal elongation ratio λ can be expressed as

$$σ = \frac{{λ}^{4} - 1}{{λ}^{3}} ( 2 {C}_{3} + 4 {{C}_{4} ( λ - \frac{1}{λ} )}^{2} )$$

The above expression is expanded, and two or more-order small quantities are ignored to obtain.

$$σ = 8 {C}_{3} ( {λ}_{3} - 1 )$$

The principal elongation ratio of the single air bag of the flexible actuator is

$${λ}_{1} = \frac{θ}{sin θ} ,$$

θ represents the bending angle of the single air bag under certain internal air pressure, i.e.,

$$θ = \frac{ϕ}{N} ,$$

ϕ is the bending angle of the flexible actuator, and N is the number of air bags.

### 3. Modeling of Hybrid Actuators

An output force model of the hybrid actuators is obtained according to the force balance relation:

$$σ - {F}_{SMA} - {F}_{0} - {F}_{Muscle} = 0$$

In the expression: F_{SMA} is the output force of shape memory alloy, F₀ is the initial force of the hybrid actuators, and F_{Muscle} is the auxiliary force of the hybrid actuators and human fingers.

Models of the SMA spring actuator and the flexible actuator are substituted into the above expression to obtain the auxiliary force of the hybrid actuators to the fingers of a patient:

$${F}_{Muscle} = \frac{{{P}_{i} ( h + t )}^{2}}{{t}^{2}} - k X - {F}_{0}$$

In the expression, x is the elongation of the spring, an expression is X=L*(λ−1)*2, Pᵢ is the internal pressure of the flexible actuator at the moment i, and L is the length of the actuator.

It should be noted that the above contents only illustrate the technical thought of the present disclosure and are not intended to limit the protection scope of the present disclosure. Many improvements and modifications can be made by those ordinarily skilled in the art without departing from the principle of the present disclosure, and these improvements and modifications still fall within the protection scope of claims of the present disclosure.

1. A flexible rehabilitation glove based on hybrid actuators, wherein the flexible rehabilitation glove comprises five hybrid actuators and an actuator control box;
each hybrid actuator comprises an actuator end mounting seat, a flexible actuator, a TPFE water pipe, a flexible actuator front section mounting seat, a flexible actuator air pipe, an air pipe connecting seat II, an SMA spring actuator, an air pipe connecting seat I and a cooling water pipe;
the flexible actuator is made of silica gel, is of a multi-cavity structure and is composed of upper and lower parts, wherein an upper layer is wavy, a hollow cavity is formed between every two wave crests, a lower layer is a rectangle, and a groove for conducting air is formed in the middle; the flexible actuator is configured to that wavy cavities are thin in a contact surface and thick in a non-contact surface, in the process of inflating the flexible actuator, the deformation of the contact surface is large, and the cavities extrude to each other, which results in the bending of the actuator;
two ends of the flexible actuator are respectively connected to the flexible actuator front section mounting seat and a flexible actuator end mounting seat, the flexible actuator is connected to an air pump through the flexible actuator air pipe, and internal air pressure is controlled by an electrical proportional valve through a control program in a control circuit board;
the SMA spring actuator is sleeved on the cooling water pipe, and the water pipe is used as a guide rail for rope movement and has the effect of cooling the spring actuator by lowering the temperature of the water pipe by means of internal water flow and enabling the water pipe to make full contact with the SMA spring actuator; the SMA spring actuator passes through two holes in the flexible actuator front section mounting seat and two holes in the flexible actuator by a rope and is connected to the actuator end mounting seat, and the flexible actuator can be assisted to provide a reverse extension force by tension of a spring;
the air pipe connecting seat I and the air pipe connecting seat II are respectively installed on two ends of each of the cooling water pipe and the flexible actuator, and the position of the water pipe is fixed by using the two connecting seats; wherein the air pipe connecting seat I fixes the end position of the SMA spring actuator, and the air pipe connecting seat II limits the range of movement of the other end of the SMA spring actuator; and
the control box comprises an air pump, a filter, a water pump and a water tank, a proportional valve and a control circuit board inside, and comprises an actuator control box body, a control box cover, a main switch, a button and a voltage display outside, and the filter is connected to the air pump and the electrical proportional valve respectively.

2. The flexible rehabilitation glove based on the hybrid actuators according to claim 1, wherein the air pump provides 250 KPa of air pressure.

3. The flexible rehabilitation glove based on the hybrid actuators according to claim 1, wherein the actuator control box and the control box cover are connected by the attractive force of magnets at four corners.

4. The flexible rehabilitation glove based on the hybrid actuators according to claim 1, wherein the TPFE water pipe is placed between the two holes in the flexible actuator.

5. The flexible rehabilitation glove based on the hybrid actuators according to claim 1, wherein the principle of movement is as follows:
the hybrid actuators are connected to the glove by using elastic bands, and the hybrid actuators are extended and bent by inflation and deflation to drive the fingers of the patient to move;
each hybrid actuator is composed of a bending actuator and an extension actuator, wherein the bending actuator is a flexible actuator, and the extension actuator is an SMA spring actuator;
the flexible actuator has an initial state and a pressurizing state, and the flexible actuator is in a rectangular shape in the initial state and in an arc shape in the pressurizing state; by controlling the internal pressure of the flexible actuator, the bending angle of the flexible actuator can be changed so as to achieve the objective of controlling the bending and extension of the flexible actuator;
the SMA spring actuator is a spring made of memory alloy, the memory alloy has two states of martensite and austenite, and the states are converted by controlling the temperature of SMA; when the temperature of the memory alloy is relatively low, the SMA spring is in the state of martensite, at the moment, an elastic coefficient of the SMA spring is relatively low, and an elastic force of the SMA spring is relatively low; and when the temperature of the memory alloy is relatively high, the SMA spring is in the state of austenite, at the moment, the elastic coefficient of the SMA spring is relatively high, and the elastic force of the spring is relatively high;
during movement in the bending direction, the internal pressure of the flexible actuator increases to drive the rope, the rope moves to pull the SMA spring actuator, and in the condition of no heating, the SMA spring actuator is cooled by the cooling water pipe, so that during extension, the SMA spring is in the state of martensite, and the SMA material of martensite has low rigidity and thus has low damping on the movement of the flexible actuator; and
in addition, during movement in the extension direction, the rigidity of the SMA spring is increased by electrifying and heating the SMA spring, the SMA spring pulls the rope to drive the flexible actuator end mounting seat to reversely move, and meanwhile, the internal pressure of the flexible actuator decreases, so that the flexible actuator is in the initial state and thus has low damping on the movement of the SMA spring.

6. The flexible rehabilitation glove based on the hybrid actuators according to claim 1, wherein in order to preferably assist patients in daily life activities, modeling analysis is performed on the hybrid actuators:
the modeling of the hybrid actuators mainly comprises the modeling of the flexible actuator and the SMA spring actuator:
1. Modeling of Memory Alloy Spring Actuator
Hooke's Law of Elasticity states:
$${F}_{SMA} = k X$$
wherein k is the elastic coefficient of the spring, and x is the deformation quantity of the spring;
in the condition of guaranteeing the accuracy of the actuator, the SMA memory alloy spring is simplified to obtain the elastic coefficient of SMA memory alloy:
$$k = \{ \begin{matrix}{k}_{A} ( {A}_{f} \leq T ) \\ {k}_{M} ( T \leq {A}_{s} )\end{matrix}$$
wherein ky is the elastic coefficient of the memory alloy spring in the state of austenite, and an expression is
$${k}_{A} = \frac{{C}_{2} {G}_{A}}{{C}_{1}} ;$$
and k_{M} is the elastic coefficient of the memory alloy spring in the state of martensite, and an expression is C₁; T is the temperature of the SMA spring, the temperature at which the austenite phase transformation begins is Aᵢ, the temperature at which the austenite phase transformation ends is A_{f}, wherein C₁ and C₂ are constants, and expressions are
$${C}_{1} = \frac{8 {k}_{s} D}{π {d}^{3}} and {C}_{2} = \frac{d}{π {D}^{2} N} ;$$
in the expressions, kₛ is the stress-corrected elastic coefficient, and the expression is
$${k}_{s} = \frac{4 C - 1}{4 C - 4} + \frac{0.165}{C}$$
in the expression, C is the spring index,
$$C = \frac{D}{d} ,$$
D is the diameter of the spring, d is the wire diameter of the spring, and N is the number of coils;
2. Modeling of Flexible Actuator
During inflation, the pressure of each cavity of the actuator is the same; the internal pressure of an air bag is set to P, force analysis is performed on the single surface of the actuator, the internal stress of the section of a base is expressed as σ, and it can be seen from a force balance equation:
$$σ {t}^{2} = {P ( h + t )}^{2}$$
in the expression, h is the internal height of the cavity, and t is the thickness of the cavity base;
on the basis of a Yeoh model, an energy equation using a typical two-parameter form is
$$U = {C}_{3} ( I - 3 ) + {{C}_{4} ( I - 3 )}^{2} = {{C}_{3} ( λ - \frac{1}{λ} )}^{2} + {{C}_{4} ( λ - \frac{1}{λ} )}^{4}$$
in the expression, C₃ and C₄ are coefficients, C₃=0.11 and C₄=0.02, I is the deformation tensor invariant, and λ is the principal elongation ratio;
the internal stress is expressed as
$$σ = \frac{\partial U}{\partial λ} ,$$
and the relationship between the internal stress σ and the principal elongation ratio λ can be expressed as
$$σ = \frac{{λ}^{4} - 1}{{λ}^{3}} ( 2 {C}_{3} + 4 {{C}_{4} ( λ - \frac{1}{λ} )}^{2} )$$
the above expression is expanded, and two or more-order small quantities are ignored to obtain.
$$σ = 8 {C}_{3} ( {λ}_{3} - 1 )$$
the principal elongation ratio of the single air bag of the flexible actuator is
$${λ}_{1} = \frac{θ}{sin θ} ,$$
θ represents the bending angle of the single air bag under certain internal air pressure, i.e.,
$$θ = \frac{ϕ}{N} ,$$
ϕ is the bending angle of the flexible actuator, and N is the number of air bags;
3. Modeling of Hybrid actuators
An output force model of the hybrid actuators is obtained according to the force balance relation:
$$σ - {F}_{SMA} - {F}_{0} - {F}_{Muscle} = 0$$
in the expression: F_{SMA} is the output force of shape memory alloy, F₀ is the initial force of the hybrid actuators, and F_{Muscle} is the auxiliary force of the hybrid actuators and human fingers;
models of the SMA spring actuator and the flexible actuator are substituted into the above expression to obtain the auxiliary force of the hybrid actuators to the fingers of a patient:
$${F}_{Muscle} = \frac{{{P}_{i} ( h + t )}^{2}}{{t}^{2}} - kX - {F}_{0}$$
in the expression, x is the elongation of the spring, an expression is X=L*(λ−1)*2, Pᵢ is the internal pressure of the flexible actuator at the moment i, and L is the length of the actuator.
